(19) United States
(12) Patent Application Publication
(10) Pub. No.: US 2014/0156654 A1
(43) Pub. Date: Jun. 5, 2014

(54) Gaze controlled contextual web search

(71) Applicant: HCL Technologies Limited, Chennai (IN)

(72) Inventors: Arindam Dutta, Noida (IN); Akhilesh Chandra Singh, NOIDA (IN)

(73) Assignee: HCL Technologies Limited, Chennai (IN)

(21) Appl. No.: 13/899,538

(22) Filed: May 21, 2013

(30) Foreign Application Priority Data
Dec. 5, 2012 (IN) 5070/CHE/2012

(51) Int. Cl. G06F 17/30

(52) U.S. Cl. CPC G06F 17/30864
USPC 707/727; 707/722

(57) ABSTRACT

The embodiments herein relate to web searches and, more particularly, to a gaze controlled approach to automate web search. The system identifies coordinates of the display unit the user is gazing at, at each instance of time and forms corresponding gaze vectors. Further, data displayed on the display unit is grouped into different semantic zones; with each semantic zone having different coordinates. By comparing coordinate information in the gaze vector and each of the semantic zones, the system identifies semantic zone the user is gazing at. Further, from the identified semantic zones, the system identifies a subject of interest for that user. A search is performed in the associated databases with the subject of interest as the key and the results are displayed to the user.

### PRIORITY DETAILS

The present application claims priority from Indian Application Number 5070/CHE/2012, filed on 5 Dec. 2012, the disclosure of which is hereby incorporated by reference herein.

### TECHNICAL FIELD

The embodiments herein relate to web searches and, more particularly, to a gaze controlled approach to automate web search.

### BACKGROUND

Internet has established itself as a highly favored knowledge sharing media. Plenty of websites are available in the internet which provides detailed explanation on various subjects/topics. A user who is searching for details related to specific topic may perform a search in any search engine which in turn searches in associated databases and displays matching results, in any specific order as set by the user.

Normally, each webpage shows information regarding multiple topics; say for example a cricket website may display information such as player profiles, team profiles, status of live matches, results of recently ended matches and so on. A user who opens that particular page may be interested in reading specific content. In the above example the user may be interested in viewing profile of a particular player. In order to view that particular player profile, the user may have to click on corresponding link, which may be a hyperlink. Similarly, the user has to manually navigate to view contents of his/her choice.

Similarly, if the user has to fetch more information regarding that particular subject (i.e. the player in this example), he/she has to continue searching using any of the available search engines. A disadvantage of these existing systems is that time consumed for manually searching for similar contents each time is more. Further, the search result accuracy may vary based on the search inputs used by the user.

### SUMMARY

A method and system for automating content search on web, the method further comprises of identifying subject of interest for a user based on gaze of the user; fetching results matching the identified subject of interest from at least one associated database; and displaying the fetched results to the user.

### BRIEF DESCRIPTION OF THE FIGURES

The embodiments herein will be better understood from the following detailed description with reference to the drawings, in which:

FIG. 1 illustrates block diagram that shows broad architecture of the gaze controlled contextual web search system, as disclosed in the embodiments herein;

FIG. 2 is a block diagram that shows various components of the gaze controlled search engine and the database unit, as disclosed in the embodiments herein;

FIG. 3 is a flow diagram that shows various steps involved in the process of gaze controlled contextual web search, as disclosed in the embodiments herein; and

FIG. 4 is a flow diagram that shows various steps involved in the process identifying user preference for content search, as disclosed in the embodiments herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

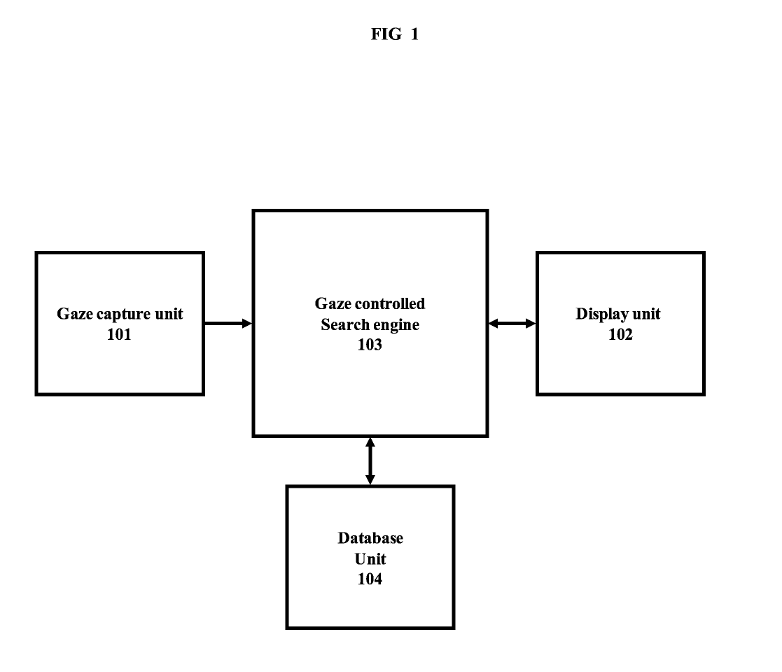

The embodiments herein disclose a contextual web search by monitoring user gaze and identifying user preference. Referring now to the drawings, and more particularly to FIGS. 1 through 4, where similar reference characters denote corresponding features consistently throughout the figures, there are shown embodiments.

FIG. 1 illustrates block diagram that shows broad architecture of the gaze controlled contextual web search system, as disclosed in the embodiments herein. The gaze controlled contextual web search system further comprises a gaze capture unit 101, a display unit 102, a gaze controlled search engine 103 and a database unit 104. The gaze capture unit 101 is preferably a camera unit that tracks user actions while he/she is browsing through a webpage. In one embodiment, the gaze controlled contextual web search system may initialize automatically when the user opens any of or a default web browser in the user device. In another embodiment, the user may have to manually initialize the gaze controlled contextual web search system. The user action may refer to head movement, gaze and/or any such actions. The data from the gaze capture unit 101 is then fed to the gaze controlled search engine 103.

The gaze controlled search engine 103 further accepts input from the display engine 102. By processing the inputs from the display unit 102 and the gaze capture unit 101, the gaze controlled search engine 102 identifies to which semantic zone (s) the user is gazing at. Further, the gaze controlled search engine 103 at least one subject of interest from a plurality of subjects in the webpage being viewed by the user. Further, the gaze controlled search engine 103 searches in the database unit 104 for all matching contents corresponding to the identified subject of interest and the results of the search are displayed to the user using the display unit 102. In various embodiments, the gaze controlled contextual web search system may be a dedicated system or may be implemented with any computing unit with inbuilt or interfaced gaze capture unit and a human readable display unit.

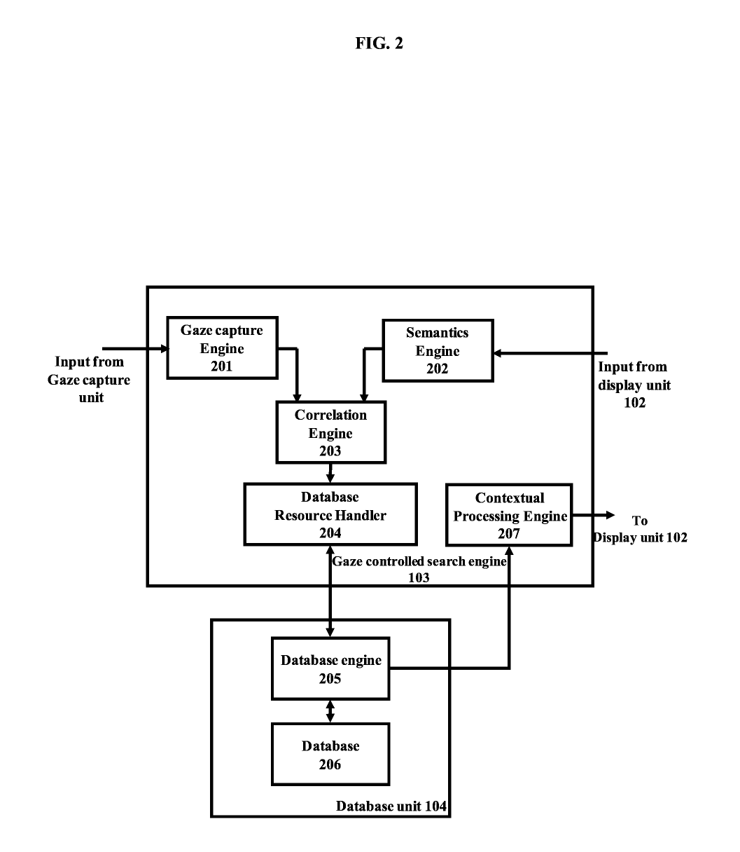

FIG. 2 is a block diagram that shows various components of the gaze controlled search engine and the database unit, as disclosed in the embodiments herein. The gaze controlled search engine 103 further comprises a gaze capture engine 201, a semantic engine 202, a correlation engine 203, a database resource handler 204 and a contextual processing engine 207. The database unit 104 further comprises a database engine 205 and a database 206.

The gaze capture engine 201 processes input received from the gaze capturing unit 101 and forms a gaze vector. The gaze vector may comprise information on coordinates on the device display unit 102 towards the user is gazing at, at each instance of time. The gaze vector information is further fed to the correlation engine 203.

The semantics engine 202 fetches input from the display unit 102 regarding displayed content, preferably a webpage. Further, the received information is processed and the contents being displayed on the webpage is grouped to different semantic zones. The semantic zone information is further fed to the correlation engine 203.

The correlation engine 203 processes the received semantic zone information and the gaze vector information and identifies to which semantic zone, the gaze vector is pointing at i.e. the semantic zone the user is gazing at. Once the semantic zone is identified, then the correlation engine 203 identifies the contents/subjects listed in that particular semantic zone. From the identified subjects, the correlation engine 203 identifies at least one subject of user's interest. Further, information regarding the identified subject of interest information is fed to the database resource handler 204.

The database resource handler 204 is connected to multiple databases 206 across various enterprises and web servers in the internet through the database engine 205. The database resource handler 204 transfers information regarding the identified subject of interest to the database engine 205. The database engine 205 searches in the associated databases 206 and fetches information related to the subject of interest.

Further, the fetched information is sent to the contextual processing engine 207. The contextual processing engine 207 categorizes data received from the database engine 205 based on types of data or in any such manner specified by a user. Further, the data is sent to the display unit 102, which is then displayed to the user.

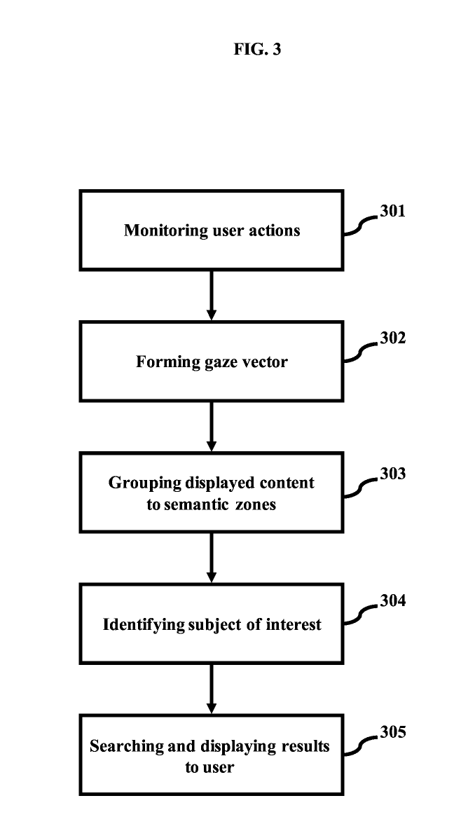

FIG. 3 is a flow diagram that shows various steps involved in the process of gaze controlled contextual web search, as disclosed in the embodiments herein. In various embodiments, the gaze controlled contextual web search system may be a dedicated system or may be implemented with any computing unit with inbuilt or interfaced gaze capture unit and a human readable display unit. When the user is browsing through a webpage, the gaze capturing unit 101 associated with the user device monitors (301) and records user action such as head movement, eye movement, eye details, and direction and towards the user is gazing at and so on.

Further, the recorded data is fed to the gaze capturing engine 201. The gaze capturing engine 201 processes the received information and forms (302) a gaze vector. The gaze capture engine 201 analyzes data such as head position, eye details and so on and measures parameters such as pixel information of eyes, distance between user head and display unit 102 and so on. The gaze capture engine 102 also fetches information regarding display dimensions of the display unit 102. By comparing the display dimensions, pixel information of the eye, distance between the user head and the display unit 102, angle at which the user is gazing at the display unit 102 and so on, the gaze capturing engine 102 identifies coordinates of the display unit 102 towards the user is gazing at, at each instance of time. This information is further embedded in the gaze vector and is then fed to the correlation engine 203.

The semantic engine 202 fetches information about content, preferably a webpage being viewed by the user at that instance of time, from the display unit 102. The semantic engine 202 then groups (303) the content being displayed on the screen/display module 102 to different semantic zones of equal size. A semantic zone may refer to a particular area of the whole screen in a specific shape; say rectangular shape. Each semantic zone may comprise information or link related to at least one subject/content. For example, when the user is browsing through a cricket related website, the webpage may display information related to various player and country profiles and statistics. Each of this player profiles and country profiles form separate subjects. The semantic engine 202 feeds the semantic zone information to the correlation engine 203.

The correlation engine 203 processes the gaze vector information and the semantic zone information and identifies to which semantic zone the gaze vector is pointing at. For example, if the gaze vector is identified to be pointing towards semantic zone “A”, then the gaze controlled contextual web search system assumes that the user is reading content/subject displayed/listed under that particular semantic zone. From the identified semantic zone, the correlation engine 203 identifies (304) at least one subject of interest for that user. Considering the above example, if user is gazing at semantic zone “A” and if the semantic zone “A” has information regarding a particular player profile, then that player/profile is considered to be subject of interest of that user.

Further, the correlation engine 203 provides information regarding the identified subject of interest to the database resource handler 204. The database resource handler 204 passes information regarding the subject of interest to the database engine 205. The database engine 205 is connected to a plurality of databases 206 across various enterprises and web servers and searches for contents related to the identified subject of interest in the associated databases 206.

Further, the matching results obtained from the database 206 are fed to the contextual processing engine 207. The contextual processing engine may categorize the received data based on various attributes such as social media trends, social sentiments, chronological, technological and so on and sends the data to the display unit 102 and is displayed to the user. The various actions in method 300 may be performed in the order presented, in a different order or simultaneously. Further, in some embodiments, some actions listed in FIG. 3 may be omitted.

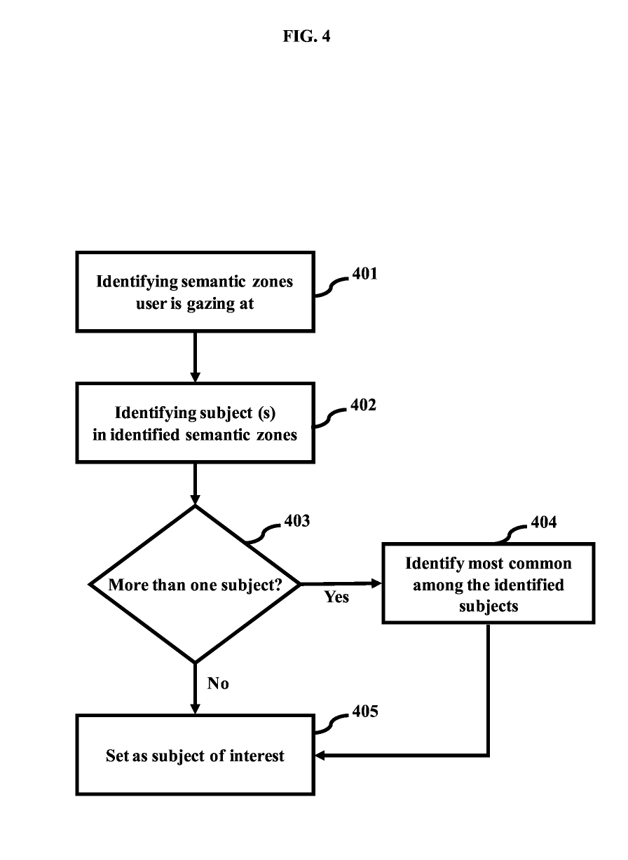

FIG. 4 is a flow diagram that shows various steps involved in the process identifying user preference for content search, as disclosed in the embodiments herein. Initially, the correlation engine 203 accepts inputs from the gaze capture engine 201 and the semantics engine 202 and processes the received inputs to identify (401) the semantic zone (s) the user is gazing at. The correlation engine 203 identifies the semantic zone to which the user is gazing at each instance of time by cross matching the gazing vector and the semantic zone information. For example, consider that the information displayed on the display unit 102 is divided into four semantic zones namely “A”, “B”, “C” and “D”. The correlation engine 203 identifies coordinates of each of the semantic zones. Further, from the gazing vector, the correlation identifies coordinate of the display unit 102 towards the user is gazing at, at that particular instance of time. The correlation engine 203 then checks whether the coordinate information present in the gazing vector matches with coordinate of any of the semantic zones. If the coordinates matches, then the correlation engine 203 assumes that the user is gazing at or is reading information in displayed in the identified semantic zone (s).

Further, the correlation engine 203 identifies the contents/subject (s) in the identified semantic zones. In an embodiment, the information regarding subjects present in each semantic zone may be provided to the correlation engine 203 by the semantic engine 202. In various other embodiments, each semantic zone may comprise one or more subjects. If the identified semantic zone (s) comprises information or link related to only one subject, then that particular subject is set (405) as the user's subject of interest.

If the identified semantic zones comprise more than one subject, then the correlation engine 203 identifies (404) most common subject among the identified subjects. For example, consider that the user is gazing at two semantic zones namely “Zone A” and “Zone B”. The correlation engine 203 identifies that Zone A comprises information related to subjects “A”, “B” and “C”, whereas Zone B comprises information related to subjects “C” and “D”. Now, in order to identify user's subject of interest, the correlation engine 203 checks for any common member among the identified subjects i.e. “C” in this example. So the correlation engine 203 considers “C” as the user's subject of interest. Further, the identified common subject is set (405) as the user's subject of interest. The various actions in method 400 may be performed in the order presented, in a different order or simultaneously. Further, in some embodiments, some actions listed in FIG. 4 may be omitted.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein specifies a system for automated web searches. The mechanism allows a gaze controlled web search, providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for automating content search on web, said method further comprises:
identifying subject of interest for a user based on gaze of said user;
fetching results matching said identified subject of interest from at least one associated database; and
displaying said fetched results to said user.

2. The method as in claim 1, wherein said identifying subject of interest further comprises:
grouping data displayed on a display unit of user device to a plurality of semantic zones;
identifying at least one of said plurality of semantic zones at which said user is gazing;
identifying subjects listed under said identified semantic zones; and
setting one of said identified subjects as said user's subject of interest.

3. The method as in claim 2, wherein said identifying at least one of said plurality of semantic zones at which said user is gazing further comprises:
forming a gaze vector for said user; and
identifying at least one of said plurality of semantic zones where said gazing vector is pointing.

4. The method as in claim 3, wherein said forming said gaze vector for said user further comprises:
tracking user actions when said user is browsing through a webpage; and
identifying coordinates on said display unit at which said user is gazing.

5. The method as in claim 3, wherein said identifying at least one of said plurality of semantic zones said gazing vector is pointing, further comprises:
fetching coordinate information on said display unit towards which said user is gazing at from said gazing vector;
comparing said fetched coordinate information with coordinate information of each of said plurality of semantic zones; and
identifying at least one semantic zone whose coordinate information matches with said fetched coordinate information from said gazing vector.

6. The method as in claim 2, wherein said setting one of said identified subjects as subject of interest for said user further comprises:
identifying if number of subjects listed under said identified semantic zones is more than one;
setting said listed subject as user's subject of interest, if number of subjects listed under said identified semantic zones not more than one;
identifying most common subject among said listed subjects, if number of subjects listed under said identified semantic zones is more than one; and
setting said identified most common subject as said subject of interest for said user.

7. A system for automating content search on web, said system is further configured for
identifying subject of interest for a user based on gaze of said user;
fetching results matching said identified subject of interest from at least one associated database; and
displaying said fetched results to said user.

8. The system as in claim 7, wherein said system is configured for identifying subject of interest by:
grouping data displayed on a display unit of user device to a plurality of semantic zones;
identifying at least one of said plurality of semantic zones at which said user is gazing;
identifying subjects listed under said identified semantic zones; and
setting one of said identified subjects as said user's subject of interest.

9. The system as in claim 8, wherein said system is configured for identifying at least one of said plurality of semantic zones at which said user is gazing further comprises by:
forming a gaze vector for said user; and
identifying at least one of said plurality of semantic zones where said gazing vector is pointing.

10. The system as in claim 9, wherein said forming said gaze vector for said user further comprises:
tracking user actions when said user is browsing through a webpage; and
identifying coordinates on said display unit at which said user is gazing.

11. The system as in claim 10, wherein said system is configured for identifying at least one of said plurality of semantic zones said gazing vector is pointing by:
fetching coordinate information on said display unit towards which said user is gazing at from said gazing vector;
comparing said fetched coordinate information with coordinate information of each of said plurality of semantic zones; and
identifying at least one semantic zone whose coordinate information matches with said fetched coordinate information from said gazing vector.

12. The system as in claim 8, wherein said system is configured for setting one of said identified subjects as subject of interest for said user by:
identifying if number of subjects listed under said identified semantic zones is more than one;
setting said listed subject as user's subject of interest, if number of subjects listed under said identified semantic zones not more than one;
identifying most common subject among said listed subjects, if number of subjects listed under said identified semantic zones is more than one; and
setting said identified most common subject as said subject of interest for said user.
